(19) United States
(12) Patent Application Publication
(10) Pub. No.: US 2023/0070290 A1
(43) Pub. Date: Mar. 9, 2023

(54) DISPLAY DEVICE AND DISPLAY SYSTEM

(71) Applicant: KABUSHIKI KAISHA TOKAI RIKA DENKI SEISAKUSHO, Aichi (JP)

(72) Inventors: Yasuhiro ONO, Aichi (JP); Masahisa DOKO, Aichi (JP)

(73) Assignee: KABUSHIKI KAISHA TOKAI RIKA DENKI SEISAKUSHO, Aichi (JP)

(21) Appl. No.: 17/759,720

(22) PCT Filed: Feb. 2, 2021
(86) PCT No.: PCT/JP2021/003624

§ 371 Date: Jul. 28, 2022

(30) Foreign Application Priority Data
Feb. 5, 2020 (JP) 2020-017807

(51) Int. Cl. G09G 3/00

(52) U.S. Cl. CPC G09G 3/001; G09G 3/3611; G09G 2320/0686; G09G 2354/00; G09G 2380/10

(57) ABSTRACT

This display device comprises: a control unit which controls the display of an image on a dimming member that is provided so as to divide the projection surface of the image by a projector into a plurality of areas; and an acquisition unit which acquires a switching signal as an image display switching request. Further, the control unit specifies an area on which the image is to be projected, from among a plurality of areas, on the basis of the switching signal. Then, the control unit adjusts the light transmittance of the dimming member and processes the image to be projected on the projection surface such that the image is projected on the projection area specified by the switching signal.

### TECHNICAL FIELD

The present invention relates to a display device and a display system.

### BACKGROUND ART

A known display system shows an image by projecting the image from a projector onto a light control member having a variable light transmittance. Patent Document 1 describes a display system that controls the light transmittance of the light control member. The light control member is controlled to become opaque when showing projected images and transparent when not showing projected images.

### Citation List

### Patent Literature

Patent Literature 1: Japanese Laid-Open Patent Publication No. 2017-90617

### SUMMARY OF INVENTION

In the display system, when a user looks at the projected image, the user may need to check the view at the other side of the surface where the image is projected while checking the projected image. In such a case, the light control member may be set to a translucent state by decreasing the light transmittance so that the other side can be seen, and the projected image and the other side of the projection surface will both be visible. However, it may be difficult to make both views clear.

An objective of the present invention is to provide a display device and a display system that improve visual recognition of both the projected image and the other side of the projection surface.

A display device that solves the above problem performs image display by projecting an image from a projector onto a light control member having a variable light transmittance and arranged on an optical material. The display device includes a controller and an acquisition unit. The controller controls the image display performed on the light control member defining a projection surface for the image to be displayed on. The projection surface is dividable into multiple areas. The acquisition unit obtains a switching signal as a switching request of the image display. The controller specifies, from the multiple areas, onto which area or areas the image is to be projected based on the switching signal. The controller adjusts the light transmittance of the light control member and processes the image that is to be projected onto the projection surface so that the image is projected onto a projection area specified by the switching signal.

A display system that solves the above problem performs image display on a light control member and includes the light control member and a projector. The light control member has a variable light transmittance and is arranged on an optical material. The projector projects the image onto the light control member. The display system also includes a signal output unit and a display device. The signal output unit outputs a switching signal as a switching request of the image display in accordance with a user operation. The display device obtains the switching signal and controls the image display. The light control member defines a projection surface for the image to be displayed on. The projection surface is dividable into multiple areas. The display device specifies, from the multiple areas, onto which area or areas the image is to be projected based on the switching signal. The display device adjusts the light transmittance of the light control member and processes the image that is to be projected onto the projection surface so that the image is projected onto a projection area specified by the switching signal.

### Advantageous Effects of Invention

The display device and the display system according to the present invention improve visual recognition of both the projected image and the other side of the projection surface.

### BRIEF DESCRIPTION OF DRAWINGS

FIG. 1 is a block diagram showing the configuration of a display system.

FIG. 2 is a schematic diagram of a projection surface divided into multiple areas.

FIG. 3 is a flowchart illustrating image display control.

FIG. 4A is a diagram showing a state of the projection surface in which the entire surface is selected as a projection area. FIG. 4B is a diagram showing an image projected onto the projection surface.

FIGS. 5A and 5B are diagrams showing the relationship of a selected projection area and a processed image.

FIG. 6 is a diagram of a display system applied to a window glass of side door for a rear seat in a vehicle.

FIGS. 7A and 7B are diagrams showing the relationship of a selected projection area and a processed image in accordance with another embodiment.

### DESCRIPTION OF EMBODIMENT

An embodiment of a display device and a display system will now be described with reference to the drawings.

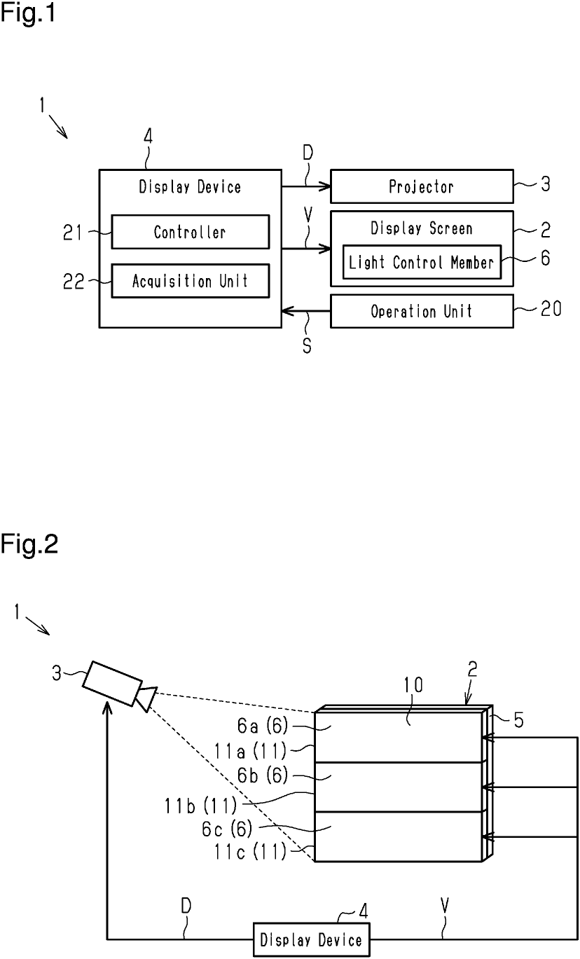

As shown in FIG. 1, a display system 1 includes a display screen 2, a projector 3, and a display device 4. The projector 3 projects an image onto the display screen 2. The display device 4 controls the shown image. The projector 3 is, for example, a laser projector. The display device 4 outputs image data D of the image that will be projected to the projector 3. The projector 3 projects the image that corresponds to the received image data D onto the display screen 2. In the present embodiment, the display screen 2 is arranged in a vehicle and shows the image to a user in the vehicle. The image includes a picture, a still image, a video, character information, and/or the like indicating various types of information.

As shown in FIG. 2, the display screen 2 includes an optical material 5 and a light control member 6. The optical material 5 is formed by a transparent member such as a light-transmissive glass. The light control member 6 is arranged on the optical material 5 and has a variable light transmittance. The light control member 6 is bonded to the optical material 5. In the present embodiment, the optical material 5 is a glass material of a vehicle. The light control member 6 is a liquid crystal material of which the light transmittance decreases in accordance with, for example, the voltage applied. For example, as the light transmittance decreases and the light control member 6 becomes opaque, the shown image projected from the projector 3 becomes clearer. The display device 4 outputs a control voltage V to the light control member 6 to control the light transmittance.

The display screen 2 includes a projection surface 10 onto which an image is projected. Further, the light control member 6 defines the projection surface 10 that is dividable into multiple areas 11. The multiple areas 11 are arranged next to one another in a vertical direction of the image projection surface 10. In the present embodiment, a plurality of light control members 6 defines the projection surface 10 that is divided into the multiple areas 11. Further, the light transmittance of each light control member 6 is independently controllable.

The projection surface 10 is divided into a first area 11a, a second area 11b, and a third area 11c. The light control members 6 include a first light control member 6a that corresponds to the first area 11a, a second light control member 6b that corresponds to the second area 11b, and a third light control member 6c that corresponds to the third area 11c.

The projector 3 is arranged on a ceiling or the like inside the passenger compartment to project an image onto the projection surface 10 from inside the passenger compartment. That is, the projector 3 is of a front projection type in which the projector 3 and the user are at the same side of the projection surface 10.

As shown in FIG. 1, the display system 1 includes an operation unit 20 serving as a signal output unit that switches image display when the user carries out an operation. The operation unit 20 is, for example, a switch operated by the user. In the present embodiment, the operation unit 20 is configured to select a projection area onto where an image is to be projected from the multiple areas 11 of the projection surface 10 in accordance with a switching operation performed by the user. The operation unit 20 outputs a switching signal S to the display device 4 as a switching request of the image display.

The display device 4 includes an acquisition unit 22 and a controller 21. The acquisition unit 22 receives the switching signal S. The controller 21 controls the image display performed on the light control member 6 based on the switching signal S. When the switching signal S is received by the acquisition unit 22, the controller 21 specifies the projection area based on the switching signal S.

When the projection area is specified, the controller 21 adjusts the light transmittance of each light control member 6. In the present embodiment, the controller 21 controls the light control members 6 in a light-controlled state that shows the projected image and a transparent state that transmits the emitted light. The controller 21 controls each light control member 6 that corresponds to the projection area in the light-controlled state and controls each light control member 6 that corresponds to an area other than the projection area (hereafter, described as excluded from projection area) in the transparent state. When the controller 21 outputs the control voltage V to a light control member 6, the light control member 6 is controlled in the light-controlled state. When the output of the control voltage V is stopped, the light control member 6 is controlled in the transparent state.

When the projection area is specified, the controller 21 processes the image that is to be projected from the projector 3. The controller 21 processes the image data D to vary the display magnification of the image that is to be projected in correspondence with the size of the projection area. Further, the controller 21 sets a blank portion in the image data D. The blank portion is where the projection surface 10 is not irradiated with the image light from the projector 3 and excluded from the projection area. The controller 21 sets the part of the image data D corresponding to the blank portion excluded from the projection area to, for example, black data.

The operation of the present embodiment will now be described.

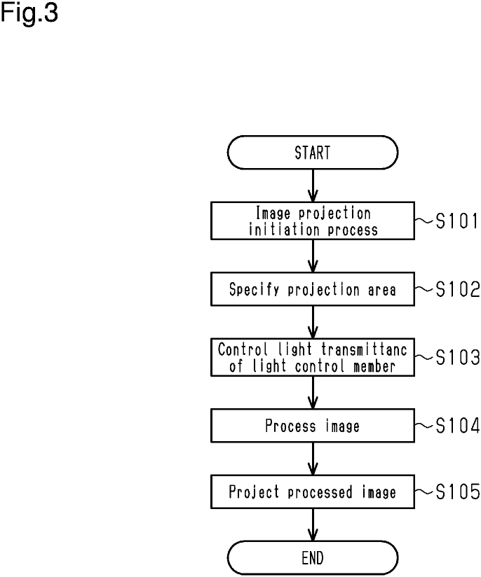

As shown in FIG. 3, in S101 (“S” stands for step), the display device 4 performs an image projection initiation process. The image projection initiation process is performed when, for example, the user carries out an operation. In the image projection initiation process, for example, the display device 4 acquires the image data D that is to be projected or reads the image data D stored in advance in a memory (not shown) of the display device 4.

In S102, when the operation unit 20 is operated by a user and outputs a switching signal S, the controller 21 receives the switching signal S with the acquisition unit 22. Then, the controller 21 specifies the projection area based on the obtained switching signal S. In this manner, the controller 21 specifies the area selected by the user by, for example, operating the operation unit 20 as the projection area.

In S103, the controller 21 controls the light transmittance of each light control member 6 in accordance with the projection area. The controller 21 outputs the control voltage V to each light control member 6 that corresponds to the projection area to control the light control member 6 in the light-controlled state. Further, the controller 21 stops the output of the control voltage V to each light control member 6 located outside the projection area to control the light control member 6 in the transparent state.

In S104, the controller 21 processes the image that is to be projected in accordance with the projection area. The controller 21 varies the display magnification of the image data D. Further, the controller 21 sets the part of the image data D that corresponds to the outside of the projection area in accordance with a blank portion.

The relationship between the state of the projection surface 10 in which the projection area is selected and the image processed in accordance with the projection area will now be described.

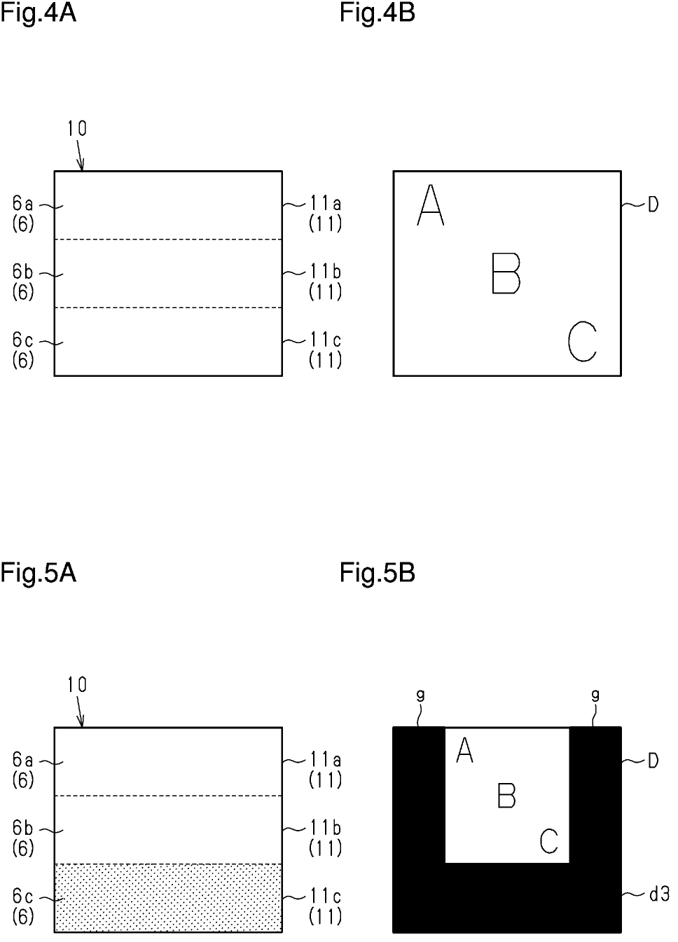

As shown in FIG. 4A, the first light control member 6a, the second light control member 6b, and the third light control member 6c are all controlled in the light-controlled state when the entire projection surface 10 is selected as the projection area, that is, when the first area 11a, the second area 11b, and the third area 11c are all selected as the projection area. In this manner, the entire projection surface 10 becomes opaque. This state shows the image on the entire projection surface 10.

As shown in FIG. 4B, the controller 21 processes the image data D so that the image is shown on the first area 11a, the second area 11b, and the third area 11c when the first area 11a, the second area 11b, and the third area 11c are all selected as the projection area. Specifically, the controller 21 varies the display magnification of the image data D in accordance with the projection area defined by the first area 11a, the second area 11b, and the third area 11c. The controller 21 does not set a blank portion in the image data D since there is no portion excluded from the projection area on the projection surface 10.

As shown in FIG. 5A, when the first area 11a and the second area 11b of the projection surface 10 are selected as the projection area, the controller 21 controls the first light control member 6a and the second light control member 6b in the light-controlled state and controls the third light control member 6c in the transparent state. In this state, only the first area 11a and the second area 11b are opaque and show the image. Also, the other side of the projection surface 10 can be viewed through the third area 11c that is transparent.

As shown in FIG. 5B, when the first area 11a and the second area 11b are selected as the projection area, the controller 21 varies the display magnification of the image in accordance with the size of the projection area defined by the first area 11a and the second area 11b. Further, the controller 21 adjusts, for example, the center position of the image, of which the display magnification has been varied, to match the center of the projection area. In this manner, the image generated from the image data D is enlarged or reduced to be included in the projection area. That is, the controller 21 adjusts the display magnification and the center position of the image data D in accordance with the one or more areas selected as the projection area, and the projector 3 projects the image corresponding to the adjusted image data D onto the one or more areas selected as the projection area. This includes the projected image in the one or more areas selected as the projection area. When the first area 11a and the second area 11b are selected as the projection area, the image arranged is reduced in size from when the entire projection surface 10 is selected as the projection area.

The controller 21 sets part d3 of the image data D that corresponds to the third area 11c located outside the projection area in accordance with a blank portion. Further, for example, when the aspect ratio of the projection area does not match the aspect ratio of the image data D, the controller 21 also sets a blank portion in a gap g formed in the projection area where no image is shown. In the present embodiment, the controller 21 sets black data for part d3 and gap g. In this state, the image generated from the image data D shows nothing in portions encompassing the enlarged or reduced image.

Returning to FIG. 3, in S105, the controller 21 outputs the processed image data D to the projector 3 and has the projector 3 project the image. The projected image is shown on each light control member 6 that is in the light-controlled state.

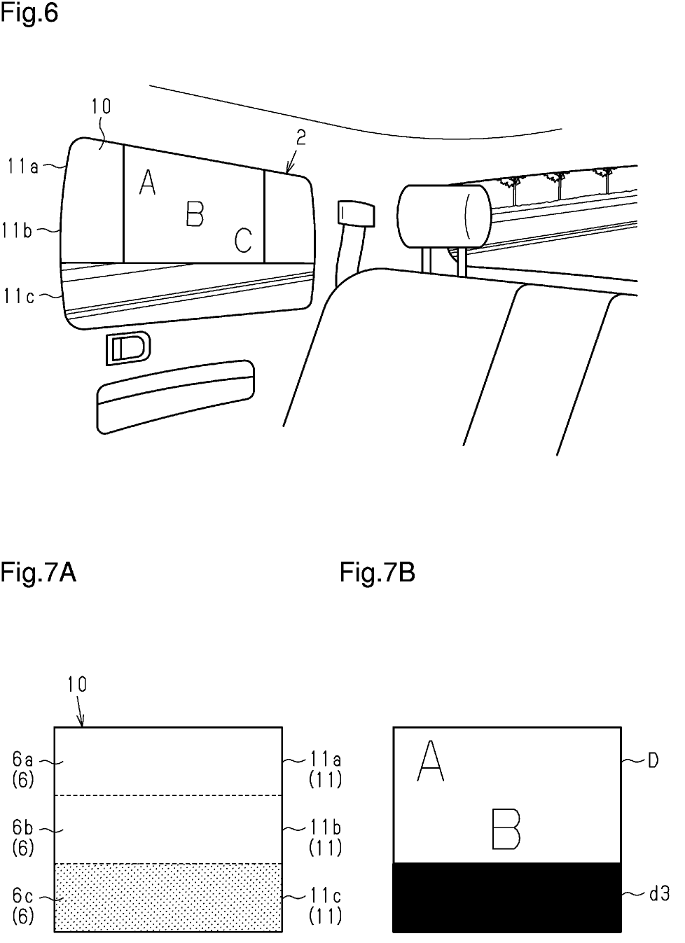

As shown in FIG. 6, the image, which is processed in correspondence with the projection area, is shown on, for example, the display screen 2 arranged on the window glass of a rear side door in the vehicle. In FIG. 6, the first area 11a and the second area 11b are selected as the projection area (same as FIGS. 5A and 5B). In the projection surface 10, the first area 11a and the second area 11b of the projection area are set in the light-controlled state and are thus opaque to show a clear image. Also, the third area 11c in the projection surface 10 is excluded from the projection area and in the transparent state. Thus, the user has a clear view of the other side of the projection surface 10 through the third area 11c. That is, the user has a clear view of the other side of the projection surface 10 through the portion in the display screen 2 outside the projection area while having a clear view of the image shown on the projection area.

A desired area 11 can be set as the projection area by operating the operation unit 20. This allows the visuality of both the image and the other side of the projection surface 10 to be adjusted and improves convenience for the user.

The controller 21 varies the display magnification of the image so that the image is included in the projection area. Thus, even if the size of the projection area is changed, the entire image will be shown in a suitable size without any portion being cut off. Further, the controller 21 sets the part of the image data D that corresponds to the outside of the projection area in accordance with a blank portion that is not irradiated with the image light from the projector 3. Accordingly, the image light will not be transmitted to the other side of the projection surface 10 through a transparent light control member 6. Accordingly, for example, a person at the other side of the projection surface 10 will not notice a bright image light.

The multiple areas 11 are arranged next to one another in the vertical direction of the projection surface 10. Thus, the light transmittance can be changed in the vertical direction. For example, the light control members 6 may be used to show an image in a window member of a vehicle or the like while blocking the outside light like a blind. This improves convenience for the user.

### The Present Embodiment Has the Following Advantages

(1) The display device 4 includes the controller 21 and the acquisition unit 22. The controller 21 controls image display performed on the light control members 6 defining the projection surface 10 for an image to be displayed on. The projection surface 10 is dividable into multiple areas 11. The acquisition unit 22 obtains a switching signal S as a switching request of the image display. Further, the controller 21 specifies, from the multiple areas 11, onto which area or areas an image is to be projected based on the switching signal S. Then, the controller 21 adjusts the light transmittance of each light control member 6 and processes the image that is to be projected onto the projection surface 10 so that the image is projected onto the projection area specified by the switching signal S. This configuration shows the image on the projection area and allows the other side to be viewed through the area excluded from the projection area. Therefore, the projected image and the other side of the projection surface 10 can both be viewed clearly.
(2) The controller 21 controls the light control members 6 in the light-controlled state that shows the projected image and the transparent state that transmits the emitted light. With this configuration, the projected image is clearly viewed in the light-controlled state, and the other side of the projection surface 10 is clearly viewed in the transparent state.
(3) The controller 21 varies the display magnification of the image that is to be projected so that the image is included in the projection area. With this configuration, even when the projection area is enlarged or reduced, the entire image will be shown without any portion being cut off. This improves visual recognition of the projected image.
(4) The controller 21 sets a blank portion in the image in correspondence with an area excluded from the projection area of the projection surface 10 that is not irradiated with the image light from the projector 3. With this configuration, no image light is emitted to the area of the projection surface 10 onto where no image is projected. Accordingly, no image light is transmitted through, for example, the outside of the projection area in the projection surface 10 to the other side of the projection surface 10. Thus, the surrounding environment will not be adversely affected.
(5) The multiple areas 11 are arranged next to one another in the vertical direction of the projection surface 10. With this configuration, the light transmittance can be changed in the vertical direction.
(6) The optical material 5 is a transparent member. With this configuration, the other side of the transparent member can be viewed while an image is shown on the transparent member such as a light-transmissive glass.
(7) The light control member 6 is arranged on a glass of a vehicle. With this configuration, the other side of the transparent member can be viewed while an image is shown in the vehicle.

The present embodiment may be modified as follows. The present embodiment and the following modifications can be combined as long as the combined modifications remain technically consistent with each other.

As shown in FIGS. 7A and 7B, the controller 21 may cut the image in correspondence with the projection area during the image processing (S104). For example, when the first area 11a and the second area 11b are selected as the projection area, part d3 of the image data D corresponding to the third area 11c may be cut and set as a blank portion.

The areas 11 may show different images that are independent from each other.

The projection area may be selected freely from the multiple areas 11. For example, the first area 11a, the second area 11b, or the third area 11c may be selected as the projection area. Alternatively, the first area 11a and the third area 11c may be selected as the projection area.

The number of the multiple areas 11 is not limited and may be two, three, four or more.

The optical material 5 of the display screen 2 is not limited to a transparent member and may be, for example, a mirror. In other words, the other side of the projection surface 10 viewed by a user does not have to be physical object and may be any visual information seen through the projection surface 10.

In the projection surface 10, the arrangement of the multiple areas 11 is not limited. For example, the multiple areas 11 may be arranged next to one another in a widthwise direction of the projection surface 10 or in a grid-like pattern.

The light control members 6 do not have to define the projection surface 10 that is divided into the multiple areas 11. For example, a single light control member 6 may be controlled to have various light transmittance. In other words, the light control member 6 only needs to be capable of dividing the projection surface 10 into the multiple areas 11.

The blank portion set in the image data D includes, not only the data of where no image light is emitted, but also data of where image light emission is more restricted than other parts.

The controller 21 does not have to set the part of an image corresponding to the outside of the projection area in accordance with a blank portion.

The controller 21 may control and actuate a shutter that blocks the image light from the projector so that no image light is emitted to the outside of the projection area.

The signal output unit may be a physical switch such as the operation unit 20, a touch-operation unit that is touch-operated, or a detector such as a camera that detects a gesture, or the like. That is, the signal output unit only needs to output a switching signal S as a switching request.

The controller 21 does not have to control the light control member 6 in two states, namely, the light-controlled state and the transparent state, and may control the light control member 6 in an intermediate state that is between the two states, for example, a translucent state.

The light transmittance of the light control member 6 in the light-controlled state is not particularly limited. The light transmittance may be varied in accordance with, for example, the visuality of the image. Further, the value of the light transmittance in the light-controlled state does not have to be the minimum value of the light transmittance of the light control member 6.

The light transmittance of the light control member 6 in the transparent state is not particularly limited. The light transmittance may be varied in accordance with, for example, the visuality of the other side of the projection surface 10. Further, the control voltage V may be applied when the light control member 6 is in the transparent state.

The light control member 6 may be transparent when no voltage is applied and have a light transmittance that is decreased in accordance with the applied voltage. Alternatively, the light control member 6 may be opaque when no voltage is applied and have a light transmittance that is increased in accordance with the applied voltage.

The light control member 6 may be a liquid crystal material, an electrochromic material, a photochromic material, or the like.

The projector 3 may be of a front projection type in which the projector 3, which projects an image, and the user are at the same side of the projection surface 10 or a rear projection type in which the projector 3, which projects an image, and the user are at opposite sides of the projection surface 10.

The projector 3 is not limited to a laser projector and may be applied to any of various types of projectors.

The installation position of the projector 3 is not limited, and the projector 3 may be arranged, for example, inside or outside the passenger compartment of a vehicle. The projector 3 may be arranged on a ceiling inside the passenger compartment or a sideview mirror outside the passenger compartment.

Image projection may be initiated by any event such as a user operation, power source transition of the vehicle, or communication with another device.

There is no limit to the content of the projected image. For example, the contents projected by an image may indicate various types of information or pictures in cooperation with an on-board device such as a navigation system and an audio device. Further, the contents projected by an image may indicate road information and/or information and advertisement of nearby facilities.

The projected image may include a picture, a still image, a video, character information, and the like.

The display system 1 does not have to be applied to a vehicle and may be arranged on various types of equipment and apparatus or in a building or facility.

The display device 4 can be circuitry including one or more processors that run on a computer program (software) to execute various processes, one or more exclusive hardware circuits such as an application specific integrated circuit (ASIC) that execute at least part of various processes, or a combination of the above. A processor includes a central processing unit (CPU) and a memory, such as a random-access memory (RAM) or a read-only memory (ROM). The memory stores program codes or commands that are configured to have the CPU execute processes. The memory, which is a computer readable medium, may be any available medium that is accessible by a versatile or dedicated computer.

Technical concepts that can be understood from the above embodiment and the modified examples will now be described.

(a) A display device that performs image display by projecting an image from a projector onto a light control member having a variable light transmittance and arranged on an optical material, the display device including circuitry configured to control the image display performed on the light control member defining a projection surface for the image to be displayed on that is dividable into multiple areas and obtain a switching signal as a switching request of the image display, in which the circuitry is configured to specify, from the multiple areas, onto which area the image is to be projected based on the switching signal, and the circuitry is configured to adjust the light transmittance of the light control member and process the image that is to be projected onto the projection surface so that the image is projected onto a projection area specified by the switching signal.

### Reference Signs List

1) display system, 2) display screen, 3) projector, 4) display device, 5) optical material, 6) light control member, 10) projection surface, 11) area, 20) operation unit, 21) controller, 22) acquisition unit, S) switching signal, V) control voltage.

1. A display device that performs image display by projecting an image from a projector onto a light control member having a variable light transmittance and arranged on an optical material, the display device comprising:
a controller that controls the image display performed on the light control member defining a projection surface for the image to be displayed on, the projection surface being dividable into multiple areas; and
an acquisition unit that obtains a switching signal as a switching request of the image display,
wherein the controller specifies, from the multiple areas, onto which area the image is to be projected based on the switching signal, and the controller adjusts the light transmittance of the light control member and processes the image that is to be projected onto the projection surface so that the image is projected onto a projection area specified by the switching signal.

2. The display device according to claim 1, wherein the controller controls the light control member in a light-controlled state that shows the projected image and a transparent state that transmits emitted light.

3. The display device according to claim 1, wherein the controller varies a display magnification of the image that is to be projected so that the image is included in the projection area.

4. The display device according to claim 1, wherein the controller sets a blank portion in the image, the blank portion being where the projection surface is not irradiated with an image light from the projector, and the blank portion corresponding to an area other than the projection area.

5. The display device according to claim 1, wherein the multiple areas are arranged next to each other in a vertical direction of the projection surface.

6. The display device according to claim 1, wherein the optical material is a transparent member.

7. The display device according to claim 6, wherein the light control member is arranged on a glass of a vehicle.

8. A display system that performs image display on a light control member and includes the light control member that has a variable light transmittance and is arranged on an optical material and a projector that projects the image onto the light control member, the display system comprising:
a signal output unit that outputs a switching signal as a switching request of the image display in accordance with a user operation; and
a display device that obtains the switching signal and controls the image display, wherein
the light control member defines a projection surface for the image to be displayed on, the projection surface being dividable into multiple areas, and
the display device specifies, from the multiple areas, onto which area the image is to be projected based on the switching signal, and the display device adjusts the light transmittance of the light control member and processes the image that is to be projected onto the projection surface so that the image is projected onto a projection area specified by the switching signal.
